(19) United States
(12) Patent Application Publication
(10) Pub. No.: US 2007/0190267 A1
(43) Pub. Date: Aug. 16, 2007

(54) Composition for forming liquid crystal orientation film, apparatus for forming liquid orientation film, and liquid crystal display

(75) Inventors: Kei Hiruma, Chino (JP); Kohei Ishida, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/705,271

(22) Filed: Feb. 12, 2007

(30) Foreign Application Priority Data
Feb. 13, 2006 (JP) 2006-034775
Jan. 10, 2007 (JP) 2007-002845

(51) Int. Cl. C09K 19/00

(52) U.S. Cl. 428/1.2

(57) ABSTRACT

A composition for forming a liquid crystal orientation film using a liquid ejection apparatus comprises (a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and (b) a material for forming a liquid crystal orientation film.

### CROSS-REFERENCE TO RELATED APPLICATIONS

This application is based upon and claims the benefit of priority from prior Japanese Patent Application No. 2006-034775, filed on Feb. 13, 2006 and Japanese Patent Application No. 2007-002845, filed on Jan. 10, 2007, the entire contents of which are incorporated herein by reference.

### FIELD OF THE INVENTION

The present invention relates to a composition for forming a liquid crystal orientation film using a liquid ejection apparatus, an apparatus for forming a liquid crystal orientation film, and a liquid crystal display having a liquid crystal orientation film.

### BACKGROUND

A method for forming a liquid crystal orientation film using a liquid ejection apparatus is known as a method for forming a liquid crystal orientation film for a liquid crystal display. In accordance with this method, a solution, or a composition for forming the liquid crystal orientation film, is ejected onto a substrate using a liquid ejection apparatus. The composition for forming a liquid crystal orientation film includes a material for forming a liquid crystal orientation film, such as polyimide or a polyamic acid, and a solvent that is appropriate for dissolving the material. The ejected composition is dried to form a film. The film is provided with liquid crystal orientation so as to form a liquid crystal orientation film. The method using a liquid ejection apparatus makes it possible to form a liquid crystal orientation film having a desired thickness in a desired location with precision and uses only a small amount of composition, and thus has been attracting attention in recent years.

As the composition for forming a liquid crystal orientation film using a liquid ejection apparatus, for example, a composition as described in Japanese Laid-Open Patent Publication 2003-295195 is known. The composition includes a material for forming a liquid crystal orientation film and a solvent including at least one type of solvent selected from γ-butylolactone and butyl cellosolve, wherein the total content of the at least one type of solvent is no less than 90 weight % of the entire solvent.

However, when the composition described in the above publication is ejected onto a substrate using a liquid ejection apparatus to form a liquid crystal orientation, undesirable streaks may occur in the film due to unevenness, which is considered to be a result from lack of wettability and spread.

### SUMMARY

One object of the present invention is to provide a composition for forming a liquid crystal orientation film that can form a uniform and flat liquid crystal orientation film without streaks using a liquid ejection apparatus.

Another object of the present invention is to provide an apparatus for forming a liquid crystal orientation film.

Yet another object of the present invention is to provide a high quality and low cost liquid crystal display having a liquid crystal orientation film which is formed using a composition for forming a liquid crystal orientation film.

According to an aspect of the invention, a composition for forming a liquid crystal orientation film using a liquid ejection apparatus is provided. The composition includes:

(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and
(b) a material for forming a liquid crystal orientation film.

According to another aspect of the invention, an apparatus for forming a crystal liquid orientation film on substrate is provided. The apparatus includes an ejection head having a plurality of nozzles; and a composition for forming a crystal liquid orientation film that is ejected from the plurality of nozzles to the substrate as a droplet. The composition includes:

(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and

(b) a material for forming a liquid crystal orientation film.

According to yet another aspect of the invention, a liquid crystal display comprising a substrate and a liquid crystal orientation film placed on the substrate is provided. The film is formed of a composition including:

(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and

(b) a material for forming a liquid crystal orientation film.

According to still another aspect of the invention, a liquid crystal display comprising an upper substrate having a liquid crystal orientation film placed thereon, a lower substrate having a liquid crystal orientation film placed thereon, a sealing material for sealing the upper and lower substrates, and liquid crystal placed in a portion surrounded by the sealing material is provided. The liquid crystal orientation film placed at least one of the upper substrate and the lower substrate is formed of a composition including:

(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and

(b) a material for forming a liquid crystal orientation film.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments, together with the accompanying drawings, in which:

FIG. 1 is a diagram illustrating an example of a manufacturing line for liquid crystal displays according to one embodiment of the present invention;

FIG. 2 is a schematic diagram illustrating an ink-jet type ejection apparatus according to one embodiment of the present invention;

FIG. 3 is a schematic cross sectional view illustrating a liquid crystal display according to one embodiment of the present invention;

FIG. 4 is a flow chart for a method for manufacturing the liquid crystal display of FIG. 3;

FIG. 5 is a schematic enlarged cross sectional view illustrating a part of a substrate during a manufacturing process for a liquid crystal display;

FIG. 6 is a schematic enlarged cross sectional view illustrating a part of a substrate during a manufacturing process for a liquid crystal display;

FIG. 7A is an elevational view illustrating a substrate during a manufacturing process for a liquid crystal display;

FIG. 7B is an cross sectional view illustrating a substrate during a manufacturing process for a liquid crystal display;

FIG. 8 is a schematic enlarged cross sectional view illustrating a part of a substrate during a manufacturing process for a liquid crystal display;

FIG. 9A is a cross sectional view of a manufacturing process of the liquid crystal display illustrating pasting the upper and lower substrates with a pasting apparatus;

FIG. 9B is a cross sectional view of a manufacturing process of the liquid crystal display illustrating setting a sealing layer formed on the substrate by ultraviolet ray;

FIG. 10 is a perspective view of the entire liquid ejection apparatus;

FIG. 11 is a bottom view illustrating a liquid ejection head viewed from the stage;

FIG. 12 is an enlarged cross sectional view illustrating a part of the liquid ejection head; and

FIG. 13 is an electrical circuit of the liquid crystal display.

### DESCRIPTION OF EXEMPLARY EMBODIMENTS

The present invention is described in detail below in the following divided sections: 1) Composition for Forming Liquid Crystal Orientation Film; and 2) Method for Manufacturing Liquid Crystal Display.

### 1) Composition for Forming Liquid Crystal Orientation Film

The composition for forming a liquid crystal orientation film according to the present invention (hereinafter also referred to as “composition of the present invention”) is a composition for forming a liquid crystal orientation film using a liquid ejection apparatus. The composition includes:

(a) a mixed solvent that includes γ-butylolactone and at least one type of solvent selected from aprotic polar solvents other than γ-butylolactone and phenol based solvents, wherein the at least one type of solvent is no less than 5 weight % of the mixed solvent; and

(b) a material for forming a liquid crystal orientation film.

(a) Mixed Solvent

In the composition of the present invention, a mixed solvent that includes γ-butylolactone and at least one type of solvent (hereinafter also referred to as “other solvent”) selected from aprotic polar solvents other than γ-butylolactone and phenol based solvents, wherein the at least one type of solvent is no less than 5 weight % of the mixed solvent, is used as a solvent for dissolving a material for forming a liquid crystal orientation film. When a mixed solvent having such composition is used, adjacent liquid drops become sufficiently compatible after being ejected from the nozzles of the liquid ejection apparatus, and thus, streaks can be completely prevented from being occurred in the resultant liquid crystal orientation film. Accordingly, a uniform and flat liquid crystal orientation film can be efficiently formed.

γ-butylolactone is a good solvent for materials for forming a liquid crystal orientation film, particularly for a polymer having at least one type selected from a repeating unit represented by the following formula (I) and a repeating unit represented by the following formula (II).

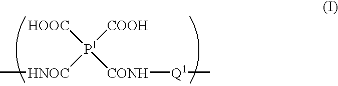

wherein P¹ is a tetravalent organic group and Q¹ is a divalent organic group.

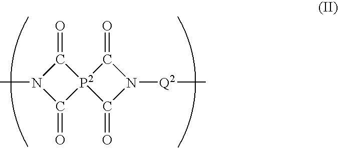

wherein P² is a tetravalent organic group and Q² is a divalent organic group.

The other solvent is also a good solvent for materials for forming a liquid crystal orientation film, particularly for a polymer having at least one type selected from a repeating unit represented by the above formula (I) and a repeating unit represented by the above formula (II).

The amount of the other solvent used is no less than 5 weight % of the entire solvent. In the case where the amount of the other solvent used is less than 5 weight %, to completely prevent streaks in the resultant liquid crystal orientation film is difficult.

When a poor solvent is added to the used solvent, it is preferred that the amount of the other solvent to be used is between no less than 5 weight % and less than 30 weight % of the entire solvent in the case, as described further below. When a mixed solvent having such a composite is used, streaks caused by unevenness as described above can be prevented, and too much spread of the solution can be prevented, and thus, formation of an uneven film can be prevented.

The aprotic polar solvents other than γ-butylolactone include, but are not limited to, amide based solvents, sulfoxide based solvents, ether based solvents and nitride based solvents. Among them, it is preferable to use amide based solvents or sulfoxide based solvents in that a highly flat and high quality liquid crystal orientation film without streaks can be formed efficiently.

The amide based solvents include, but are not limited to, N-methyl-2-pyrrolidone, N,N-dimethyl acetamide, N,N-dimethyl formamide, hexamethyl phosphoramide and tetramethylurea.

The sulfoxide based solvents include, but are not limited to, dimethyl sulfoxide and diethyl sulfoxide.

The phenol based solvents include, but are not limited to, cresols, such as o-cresol, m-cresol and p-cresol; xylenols, such as o-xylenol, m-xylenol and p-xylenol; phenol; and phenol halides, such as o-chlorophenol, m-chlorophenol, o-bromophenol and m-bromophenol.

Among these aprotic polar solvents, amide based solvents are preferable, and N-methyl-2-pyrrolidone is particularly preferable.

Regarding the composition of the present invention, it is preferable that the mixed solvent further includes a poor solvent. When the poor solvent is used, the solution can be prevented from spreading too much, and unevenness of the film can be prevented.

The poor solvent to be used includes, but is not limited to, alcohol based solvents, such as methyl alcohol, ethyl alcohol, isopropyl alcohol, cyclohexanol, 4-hydroxy-4-methyl-2-pentanone (diacetone alcohol), ethylene glycol, propylene glycol, 1,4-butanediol and triethylene glycol; ketone based solvents, such as acetone, methyl ethyl ketone, methyl isobutyl ketone and cyclohexanone; ether based solvents, such as ethylene glycol monomethyl ether, diethyl ether, ethylene glycol methyl ether, ethylene glycol ethyl ether, ethylene glycol-n-propyl ether, ethylene glycol isopropyl ether, ethylene glycol-n-butyl ether (butyl cellosolve), ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate and tetrahydrofuran; ester based solvents, such as ethyl lactate, butyl lactate, methyl acetate, ethyl acetate, butyl acetate, methyl methoxypropionate, ethyl ethoxypropionate, diethyl oxalate and diethyl malonate; hydrocarbon halide based solvents, such as dichloromethane, 1,2-dichloroethane, 1,4-dichlorobutane, trichloroethane, chlorobenzene and o-dichlorobenzene; aliphatic hydrocarbon based solvents, such as n-hexane, n-heptane and n-octane; and aromatic hydrocarbon based solvents, such as benzene, toluene and xylene. These solvents may be used alone or two or more can be used in combination.

Among them, butyl cellosolve is particularly preferable, because an even flatter liquid crystal orientation film can be efficiently obtained.

Though the amount of poor solvent is not particularly limited, it is preferable that it is between 2 weight % and 5 weight % of the entire solvent. When the poor solvent is used within this range of ratio, the wettability and leveling of the composition of the present invention to the surface of a substrate are improved so that a uniform and highly flat liquid crystal orientation film without unevenness can be formed.

(b) Material for Forming Liquid Crystal Orientation Film

The material for forming a liquid crystal orientation film that is used for the composition of the present invention is not particularly limited and any materials for forming a liquid crystal orientation film which are known in the art can be used. Such materials include, but are not limited to, polyamic acid, polyimide, polyamic acid ester, polyester, polyamide, polysiloxane, cellulose derivatives, polyacetal, polystyrene derivatives, poly(styrene-phenylmaleimide) derivatives and poly(meth)acrylate.

Among them, polymers having at least one type selected from a repeating unit represented by the above described formula (I) and a repeating unit represented by the above described formula (II) are preferable, because an orientation film having excellent liquid crystal orientation can be formed.

Examples of such polymers include:

(i) polyamic acid having a repeating unit represented by the above described formula (I),
(ii) imidized polymers having a repeating unit represented by the above described formula (II), and
(iii) block copolymers having an amic acid prepolymer having a repeating unit represented by the above described formula (I) and an imide prepolymer having a repeating unit represented by the above described formula (II). These polymers may be used alone or in combination. When two or more types are used in combination, a mixture of polyamic acid and an imidized polymer is preferable.
(i) Polyamic Acid

Polyamic acid can be obtained through reaction between tetracarboxylic acid dianhydride and diamine.

The tetracarboxylic acid dianhydride used for synthesis of polyamic acid includes, but is not limited to, alicyclic tetracarboxylic acid dianhydride such as 1,2,3, 4-cyclobutane tetracarboxylic acid dianhydride, 1,2-dimethyl-1,2,3,4-cyclobutane tetracarboxylic acid dianhydride, 1,3-dimethyl-1,2,3,4-cyclobutane tetracarboxylic acid dianhydride, 1,3-dichloro-1,2,3,4-cyclobutane tetracarboxylic acid dianhydride, 1,2,3,4-tetramethyl-1,2,3,4-cyclobutane tetracarboxylic acid dianhydride, 1,2,3,4-cyclopentane tetracarboxylic acid dianhydride, 1,2,4,5-cyclohexane tetracarboxylic acid dianhydride, 3,3′,4,4′-dicyclohexyl tetracarboxylic acid dianhydride, cis-3,7-dibutyl cycloocta-1,5-diene-1,2,5, 6-tetracarboxylic acid dianhydride, 2,3,5-tricarboxycyclopentyl acetic acid dianhydride, 3,5,6-tricarbonyl-2-carboxynorbornane-2:3,5:6-dianhydride, 2, 3,4,5-tetrahydrofuran tetracarboxylic acid dianhydride, 1, 3,3a,4,5,9b-hexahydro-5(tetrahydro-2,5-dioxo-3-furanyl)-naphtho[1,2-c]-furan-1,3-dione, 1,3,3a, 4,5, 9b-hexahydro-5-methyl-5(tetrahydro-2,5-dioxo-3-furanyl)-naphtho[1,2-c]-furan-1,3-dione, 1,3,3a,4,5,9b-hexahydro-5-ethyl-5(tetrahydro-2,5-dioxo-3-furanyl)-naphtho[1,2-c]-furan-1,3-dione, 1,3,3a,4,5,9b-hexahydro-7-methyl-5(tetrahydro-2,5-dioxo-3-furanyl)-naphtho[1,2-c]-furan-1,3-dione, 1,3,3a,4,5,9b-hexahydro-7-ethyl-5(tetrahydro-2,5-dioxo-3-furanyl)-naphtho[1,2-c]-furan-1,3-dione, 1,3,3a,4,5,9b-hexahydro-8-methyl-5(tetrahydro-2,5-dioxo-3-furanyl)-naphtho[1,2-c]-furan-1,3-dione, 1,3,3a,4,5,9b-hexahydro-8-ethyl-5(tetrahydro-2,5-dioxo-3-furanyl)-naphtho[1,2-c]-furan-1,3-dione, 1,3,3a,4,5,9b-hexahydro-5,8, dimethyl-5(tetrahydro-2,5-dioxo-3-furanyl)-naphtho[1,2-c]-furan-1,3-dione, 5-(2,5-dioxo tetrahydrofural)-3-methyl-3-cyclohexane-1,2-dicarboxylic acid dianhydride, bicycle[2,2,2]-octo-7-ene-2,3,5,6-tetracarboxylic acid dianhydride, 3-oxabicyclo[3,2,1]octane-2,4-dione-6-spiro-3′-(tetrahydrofuran-2′,5′-dione) and compounds represented by the following formulas (1) and (2)

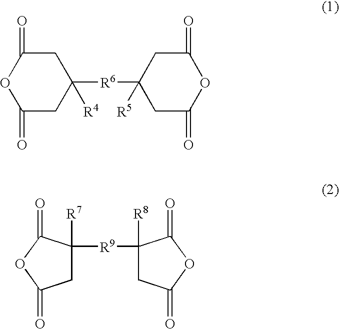

(wherein R⁴, R⁵, R⁷ and R⁸ independently represent hydrogen atoms or alkyl groups, and R⁶ and R⁹ independently represent divalent organic groups having an aromatic ring); aliphatic tetracarboxylic acid dianhydride such as butane tetracarboxylic acid dianhydride; and aromatic tetracarboxylic acid dianhydride such as pyromellitic acid dianhydride, 3,3′,4,4′-benzophenone tetracarboxylic acid dianhydride, 3,3′,4,4′-biphenyl sulfone tetracarboxylic acid dianhydride, 1,4,5,8-naphthalene tetracarboxylic acid dianhydride, 2,3,6,7-naphthalene tetracarboxylic acid dianhydride, 3,3′,4,4′-biphenyl ether tetracarboxylic acid dianhydride, 3,3′,4, 4′-dimethyl diphenyl silane tetracarboxylic acid dianhydride, 3,3′,4,4′-tetraphenyl silane tetracarboxylic acid dianhydride, 1,2,3,4-furan tetracarboxylic acid dianhydride, 4,4′-bis(3,4-dicarboxyphenoxy) diphenyl sulfide dianhydride, 4,4′-bis(3, 4-dicarboxyphenoxy) diphenyl sulfone dianhydride, 4,4′-bis(3,4-dicarboxyphnenoxy) diphenyl propane dianhydride, 3, 3′,4,4′-perfluoro isopropylidene diphthalic acid dianhydride, 3,3′,4,4′-biphenyl tetracarboxylic acid dianhydride, bis(phthalic acid) phenyl phosphine oxide dianhydride, p-phenylene-bis(triphenyl phthalic acid) dianhydride, m-phenylene-bis(triphenyl phthalic acid) dianhydride, bis(triphenyl phthalic acid)-4,4′-diphenyl ether dianhydride, bis(triphenyl phthalic acid)-4,4′-diphenyl methane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl) propane-bis(anhydrotrimellitate) and aromatic tetracarboxylic acid dianhydrides having a steroid skeleton represent by the one of the following formulas (3) to (6). These tetracarboxylic acid dianhydrides can be used alone or in combination.

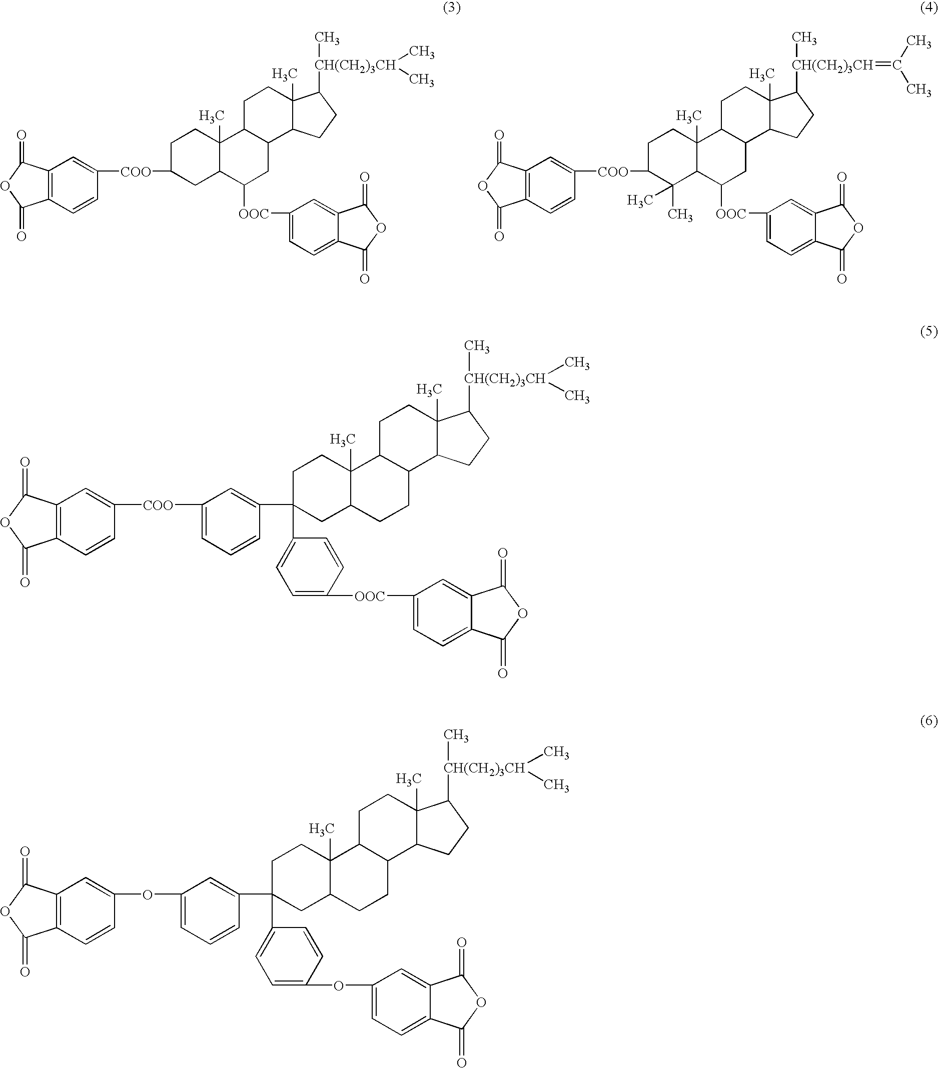

The diamine used for synthesis of polyamic acid includes, but is not limited to, aromatic diamines such as p-phenylene diamine, m-phenylene diamine, 4,4′-diamino diphenyl methane, 4,4′-diamino diphenyl ethane, 4,4′-diamino diphenyl sulfide, 4,4′-diamino diphenyl sulfone, 2,2′-dimethyl-4,4′-diamino biphenyl, 3,3′-dimethyl-4,4′-diamino biphenyl, 4,4′-diamino benzanilide, 4,4′-diamino diphenyl ether, 1,5-diamino naphthalene, 3,3-dimethyl-4,4′-diamino biphenyl, 5-amino-1-(4′-aminophenyl)-1,3,3-trimethyl indan, 6-amino-1-(4′-aminophenyl)-1,3,3-trimethyl indan, 3,4′-diamino diphenyl ether, 3,3′-diamino benzophenone, 3,4′-diamino benzophenone, 4,4′-diamino benzophenone, 2,2-bis[4-(4-aminophenoxy) phenyl]propane, 2,2-bis[4-(4-aminophenoxy) phenyl]hexafluoropropane, 2,2-bis(4-aminophenyl) hexafluoropropane, 2,2-bis[4-(4-aminophenoxy) phenyl]sulfone, 1,4-bis(4-aminophenoxy) benzene, 1,3-bis(4-aminophenoxy) benzene, 1,3-bis(3-aminophenoxy) benzene, 9,9-bis(4-aminophenyl)-10-hydroanthracene, 2,7-diamino fluorene, 9,9-bis(4-aminophenyl) fluorene, 4,4′-methylene-bis(2-chloroaniline), 2,2′,5,5′-tetrachloro-4, 4′-diamino biphenyl, 2,2′-dichloro-4,4′-diamino-5,5′-dimethoxy biphenyl, 3,3′-dimethoxy-4,4′-diamino biphenyl, 1,4,4′-(p-phenylene isopropylidene) bisaniline, 4,4′-(m-phenylene isopropylidene) bisaniline, 2,2-bis[4-(4-amino-2-trifluoromethyl phenoxy) phenyl]hexafluoropropane, 4, 4′-diamino-2,2′-bis(trifluoromethyl) biphenyl, and 4,4′-bis[(4-amino-2-trifluoromethyl) phenoxy]-octafluoro biphenyl; aliphatic and alicyclic diamines such as 1,1-methaxylylene diamine, 1,3-propane diamine, tetramethylenediamine, pentamethylenediamine, hexamethylenediamine, heptamethylenediamine, octamethylenediamine, nonamethylenediamine, 4,4-diamino heptamethylenediamine, 1, 4-diaminocyclohexane, isophoronediamine, tetrahydrodicyclopentadienylene diamine, hexahydro-4,7-methanoindanylene dimethylenediamine, tricyclo[6.2.1.02, 7]-undecylene dimethyl diamine, 4,4′-methylene bis(cyclohexylamine); diamines having two primary amino groups and a nitrogen atom other than those in the primary amino groups within the molecules, such as 2,3-diamino pyridine, 2,6-diamino pyridine, 3,4-diamino pyridine, 2,4-diamino pyrimidine, 5, 6-diamino-2,3-dicyanopyrazine, 5,6-diamino-2,4-dihydroxypyrimidine, 2,4-diamino-6-dimethyl amino-1,3,5-triazine, 1,4-bis(3-aminopropyl) piperazine, 2,4-diamino-6-isopropoxy-1,3,5-triazine, 2,4-diamino-6-methoxy-1,3, 5-triazine, 2,4-diamino-6-phenyl-1,3,5-triazine, 2,4-diamino-6-methyl-s-triazine, 2,4-diamino-1,3,5-triazine, 4,6-diamino-2-vinyl-s-triazine, 2,4-diamino-5-phenyl thiazole, 2,6-diaminopurine, 5,6-diamino-1,3-dimethyluracil, 3,5-diamino-1,2,4-triazole, 6,9-diamino-2-ethoxy acridine lactate, 3,8-diamino-6-phenyl phenantridine, 1,4-diaminopiperazine, 3,6-diaminoacridine and bis(4-aminophenyl) phenyl amine; and diaminoorgano siloxane represented by the following formula (7):

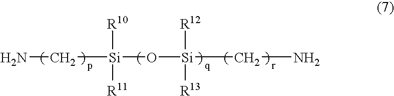

(wherein R¹⁰ to R¹³ independently represent hydrocarbon groups having the carbon number of 1 to 12, p and r are independent integers of 1 to 3, and q is an integer of 1 to 20). These diamines can be used alone or in combination.

In addition, when it is desired for the composition of the present invention to have a pre-tilt angle (an inclination angle of liquid crystal molecules relative to the substrate), it is preferable for a portion or the entire of Q¹ in the above described formula (I) and/or Q² in the above described formula (II) to be at least one type from the groups represented by the following formulas (8) and (9).

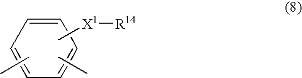

(wherein X¹ is a single bond, —O—, —CO—, —COO—, —OCO—, —NHCO—, —CONH—, —S— or an arylene group, and R¹⁴ is an alkyl group having the carbon number of 1 to 20, a monovalent organic group having an alicyclic skeleton having the carbon number of 4 to 40, or a monovalent organic group having a fluorine atom having the carbon number of 6 to 20.)

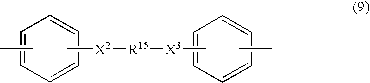

(wherein X² and X³ are independently a single bond, —O—, —CO—, —COO—, —OCO—, —NHCO—, —CONH—, —S— or an arylene group, and R¹⁵ is a divalent organic group having an alicyclic skeleton having the carbon number of 4 to 40.)

The alkyl group having the carbon number of 10 to 20 represented by R¹⁴ in the formula (8) includes, but is not limited to, an n-decyl group, an n-dodecyl group, an n-pentadecyl group, an n-hexadecyl group, an n-octadecyl group and an n-eicosyl group.

The organic groups having an alicyclic skeleton having the carbon number of 4 to 40 represented by R¹⁴ in the formula (8) and R¹⁵ in the formula (9) include, but are not limited to, groups having an alicyclic skeleton originating from a cycloalkane, such as cyclobutane, cyclopentane, cyclohexane or cyclodecane; groups having a steroid skeleton, such as cholesterol or chorestanol; and groups having a bridged alicyclic skeleton, such as norbornene or adamantine. Here, the organic groups having an alicyclic skeleton may be substituted with a halogen atom, preferably a fluorine atom, or a fluoroalkyl group, preferably a trifluoromethyl group.

The organic group having a fluorine atom having the carbon number of 6 to 20 represented by R¹⁴ in the formula (8) includes, but is not limited to, groups obtained by substituting some or all hydrogen atoms in the organic groups, for example, of alkyl groups in straight chain form having the carbon number of no less than 6, such as an n-hexyl group, an n-octyl group or an n-decyl group; alicyclic hydrocarbon groups having the carbon number of no less than 6, such as a cyclohexyl group or a cyclooctyl group; and aromatic hydrocarbon groups having the carbon number of no less than 6, such as a phenyl group or a biphenyl group, with a fluorine atom or a fluoroalkyl group such as a trifluoromethyl group.

In addition, the arylene groups X¹ to X³ in the formulas (8) and (9) include, but are not limited to, a phenylene group, a tolylene group, a biphenylene group and a naphthylene.

Preferred examples of diamines having a group represent by the formula (8) are dodecanoxy-2,4-diaminobenzene, pentadecanoxy-2,4-diaminobenzene, hexadecanoxy-2,4-diaminobenzene, octadecanoxy-2,4-diaminobenzene and compounds represent by the following formulas (10) to (15).

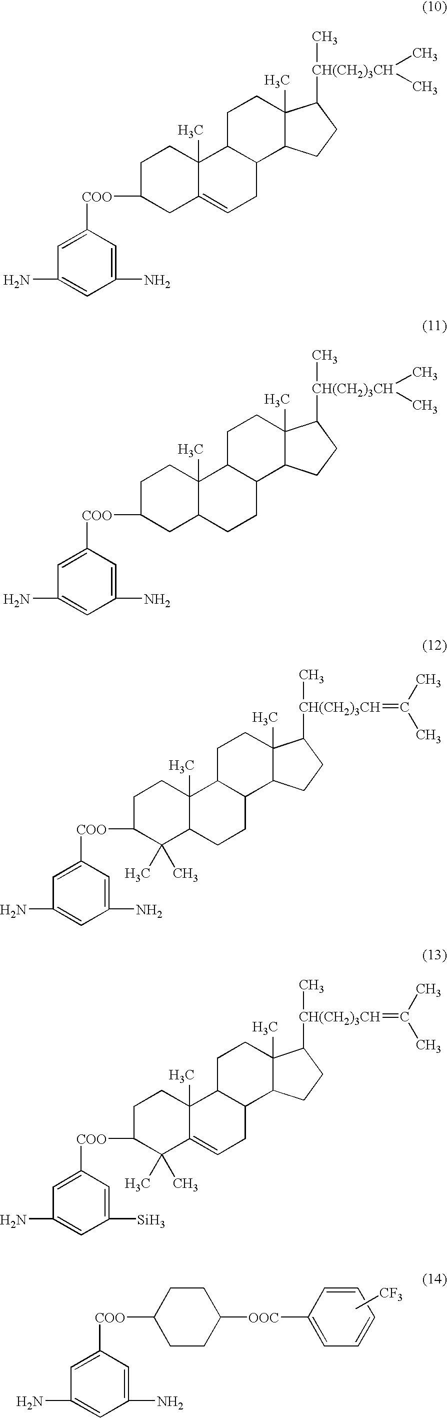

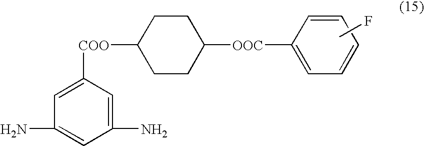

Preferred examples of diamines having a group represent by the formula (9) are diamines represent by the following formulas (16) to (18).

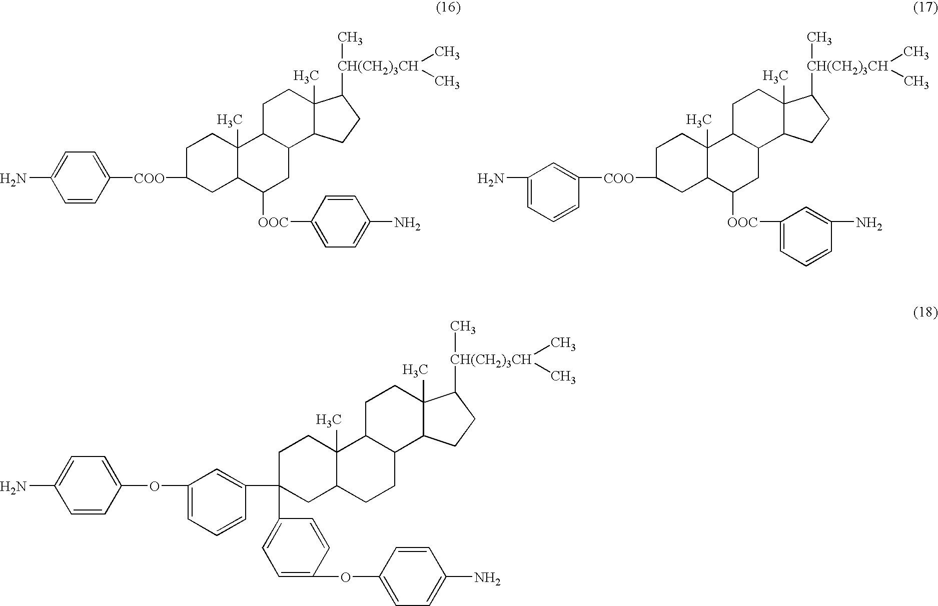

Though the ratio of the specific diamine to the total amount of diamines differs depending on the size of the desired pretilt angle, it is preferably 0 mol % to 5 mol % in the case of TN type or STN type liquid crystal display elements and 5 mol % to 100 mol % in the case of vertical orientation type liquid crystal display elements.

Polyamic acid can be produced through reaction between the tetracarboxylic acid dianhydride and the diamine as described above in an appropriate organic solvent, usually at a temperature from −20° C. to +150° C., preferably from 0° C. to 100° C.

The ratio of the tetracarboxylic acid dianhydride to the diamine is preferably 0.2 equivalents to 2 equivalents of the anhydride group of the tetracarboxylic acid dianhydride relative to 1 equivalent of the amino group of the diamine, and it is more preferably 0.3 equivalents to 1.2 equivalents.

The organic solvent used in the synthesis reaction of polyamic acid is not particularly limited, as long as it can dissolve polyamic acid. The organic solvent include aprotic polar solvents, such as N-methyl-2-pyrrolidone, N, N-dimethyl acetamide, N,N-dimethyl formamide, dimethyl sulfoxide, γ-butylolactone, tetramethylurea and hexamethyl phosphortriamide; and phenol based solvents, such as m-cresol, xylenol, phenol and phenol halides, can be cited as examples.

The amount of organic solvent (α) is preferably an amount in which the total amount (β) of the tetracarboxylic acid dianhydride and the diamine compound becomes 0.1 weight % to 30 weight % of the total amount of the reacted solution (α+β).

A poor solvent for a polyamic acid can be used together with the organic solvent in a range where the resultant polyamic acid does not deposit.

The poor solvent for a polyamic acid may include the same solvents as those described above as poor solvents for the material for forming a liquid crystal orientation film. These solvents can be used alone or in combination.

A reaction liquid including a polyamic acid is poured into a large amount of poor solvent to obtain a deposit. This deposit is dried under reduced pressure to isolate a polyamic acid.

In addition, the process in which the resultant polyamic acid is dissolved in an organic solvent again and then made to deposit using a poor solvent is carried out once or several times, thereby, polyamic acid is refined.

(ii) Imidized Polymer

Imidized polymers can be obtained by dehydrating and cyclizing a polyamic acid as described above in accordance with a well-known method, for example the method described in Japanese Laid-Open Patent Publication 2003-295195. In the imidized polymer, it is not necessary for 100% of the repeating units to be dehydrated and cyclized. The ratio of the repeating units having an imide ring to all the repeating units (hereinafter referred to as “imidization ratio”) may be less than 100%.

Though the imidization ratio in the imidized polymer is not particularly limited, it is preferably no less than 40 mol %, more preferably no less than 70 mol %. By using a polymer having the imidization ratio no less than 40 mol %, a composition with which it is possible to form a liquid crystal orientation film having a short time period for erasing afterimages can be obtained.

The polymer used in the present invention may be a type the terminals of which are modified so as to adjust the molecular weight. Such a terminally modified polymer is used, and thus, the application properties of the composition for forming a liquid crystal orientation film can be improved without impairing the effects of the present invention.

The terminally modified polymer can be synthesized by adding an acid monoanhydride, a monoamine compound and a monoisocyanate compound to a reaction system when a polyamic acid is synthesized. The acid monoanhydride includes, but is not limited to, maleic acid anhydride, phthalic acid anhydride, itaconic acid anhydride, n-decyl succinic acid anhydride, n-dodecyl succinic acid anhydride, n-tetradecyl succinic acid anhydride and n-hexadecyl succinic acid anhydride. The monoamine compound includes, but is not limited to, aniline, cyclohexyl amine, n-butyl amine, n-pentyl amine, n-hexyl amine, n-heptylamine, n-octyl amine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine and n-eicosylamine. The monoisocyanate compound includes, but is not limited to, phenyl isocyanate and naphthyl isocyanate.

(iii) Block Copolymer

A Block copolymer can be obtained by synthesizing an amic acid prepolymer having an amino group or an acid anhydride group at a terminal and an imide prepolymer having an acid anhydride group or an amino group at a terminal, respectively, and bonding the amino group and the acid anhydride group at the terminals of the respective prepolymers.

The amic acid prepolymer can be synthesized in accordance with the same method as the above described method for synthesizing a polyamic acid. In addition, the imide prepolymer can be synthesized in the same manner as in the above described method for synthesizing an imidized polymer. The functional group at a terminal can be selected by adjusting the amount of the tetracarboxylic acid dianhydride and the diamine at the time of synthesis of a polyamic acid.

The composition of the present invention may further include a compound containing functional silane or a compound containing an epoxy group, in addition to the above described mixed solvent and the material for forming a liquid crystal orientation film, so that the adhesiveness to the surface of the substrate is increased.

The compound containing functional silane and the compound containing an epoxy group are not particularly limited and any compounds known as the prior art can be used. The mixture ratio of the compound containing functional silane or the compound containing an epoxy group is usually no greater than 40 weight parts relative to 100 weight parts of the material for forming a liquid crystal orientation film, preferably no greater than 30 weight parts.

The composition of the present invention can be manufactured by dissolving or dispersing, preferably dissolving, the material for forming a liquid crystal orientation film and, if desired, the compound containing functional silane or the compound containing an epoxy group in the mixed solvent.

The concentration of the solid in the resultant composition is selected taking properties such as the viscosity and the volatility into consideration, and preferably, is in a range from 1 weight % to 10 weight %. When the concentration of the solid is less than 1 weight %, the film thickness of the applied film of the composition becomes too small to obtain a good liquid crystal orientation film. When the solid concentration exceeds 10 weight %, the film thickness of the applied film becomes too great to obtain a good liquid crystal orientation film, and in this case, the viscosity of the composition becomes great, making the application properties inferior.

Although the surface tension of the composition of the present invention is not particularly limited, it is preferably 30 mN/m to 45 mN/m (20° C.). The compositions having the surface tension in a range from 30 mN/m to 45 mN/m (20° C.) have excellent wettability on the surface of the substrate, and thus allow an applied film having a uniform thickness to be efficiently formed using a liquid ejection apparatus.

Although the viscosity of the composition of the present invention is not particularly limited, it is preferably 3 mPa·s to 20 mPa·s (20° C.). When the viscosity is adjusted to within this range, a composition for forming a liquid crystal orientation film having excellent fluidity can be obtained, and ejection of the composition from a liquid ejection apparatus becomes stable.

The composition of the present invention allows for the formation of a liquid crystal orientation film without streaks caused by unevenness, and therefore, a yield of the film can be increased a great deal. In addition, the composition of the present invention is excellent in terms of the leveling properties, and thus, allows an applied film having a uniform thickness and a flat surface to be formed. This allows a high quality orientation film to be formed whereby a high quality liquid crystal display can be manufactured.

### 2) Method for Manufacturing Liquid Crystal Display

The manufacturing method for a liquid crystal display of the present invention includes providing a substrate having a surface, providing a liquid ejection apparatus and applying the composition of the present invention on the surface of the substrate using the liquid ejection apparatus so that a liquid crystal orientation film is formed.

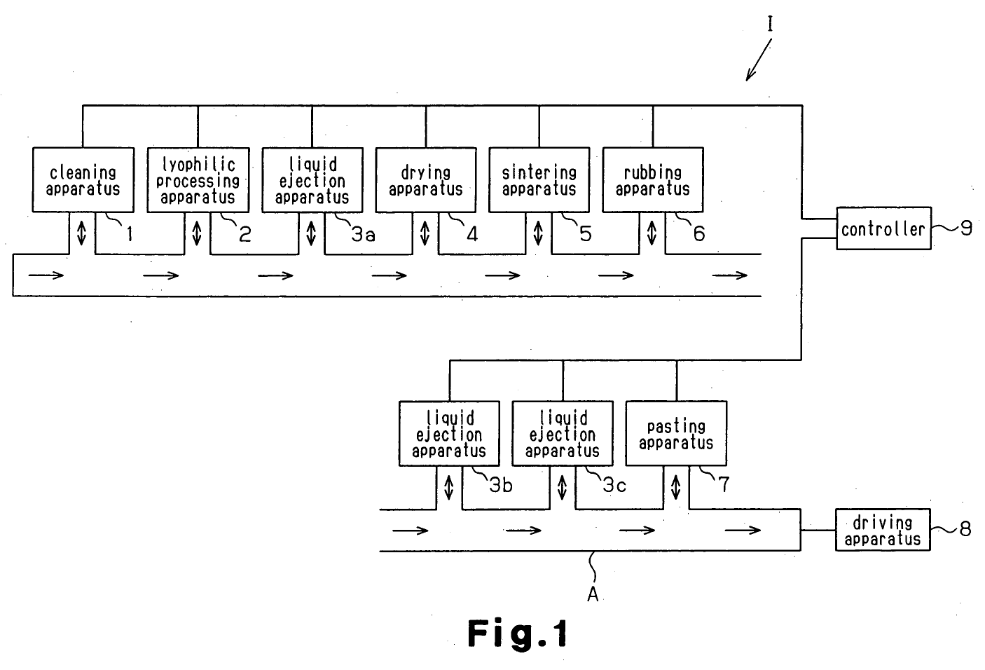

The manufacturing method for a liquid crystal display of the present invention can be implemented using a manufacturing line for a liquid crystal display as illustrated in, for example, FIG. 1.

As illustrated in FIG. 1, a liquid crystal display manufacturing line I include a cleaning apparatus 1, a lyophilic processing apparatus 2, a liquid ejection apparatus 3a, a drying apparatus 4, a sintering apparatus 5, a rubbing apparatus 6, a liquid ejection apparatus 3b, a liquid ejection apparatus 3c, a pasting apparatus 7, a belt conveyor A for connecting the respective apparatus, a driving apparatus 8 for driving the belt conveyor A, and a controlling apparatus or a controller 9 for controlling the entire manufacturing line I. Each apparatus is used in each step.

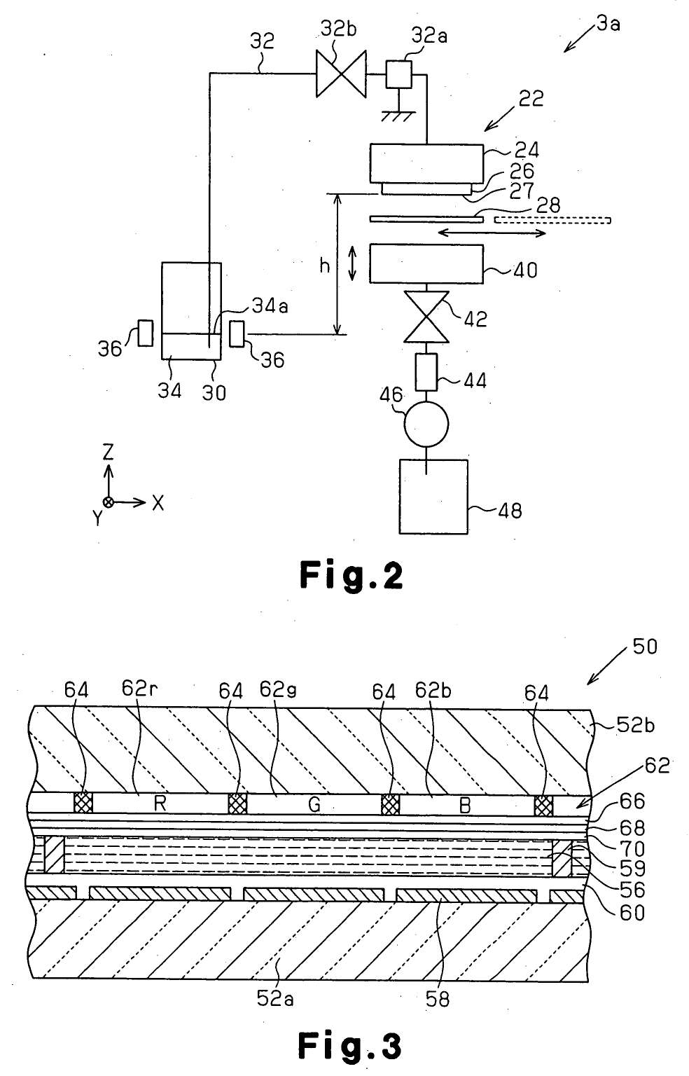

FIG. 2 illustrates an example of the liquid ejection apparatus used in the present invention. FIG. 2 is a schematic diagram illustrating an ink-jet type ejection apparatus 3a. The ejection apparatus 3a is not particularly limited as long as it is a so-called ink-jet type ejection apparatus. Examples of the ejection apparatus 3a include a thermal type ejection apparatus for ejecting droplets by creating bubbles through heating and a piezo type ejection apparatus for ejecting droplets through compression using a piezo element.

The ejection apparatus 3a includes an ink-jet head 22 which ejects a material to be ejected, or the composition of the present invention, onto a substrate. The ink-jet head 22 includes a head main body 24 and a nozzle formation surface 26 having a number of nozzles for ejection a material to be ejected. The material to be ejected is ejected from the nozzles of this nozzle formation surface 26 onto a substrate.

The ejection apparatus 3a includes a table 28 on which a substrate is mounted. The table 28 is installed so as to be moveable in a predetermined direction, for example in the direction of the X axis, in the direction of the Y axis and in the direction of the Z axis. In addition, the table 28 moves in the direction along the X axis, as illustrated by the arrow in FIG. 2, and thus, allows a substrate conveyed on the belt conveyor A to be mounted on the table 28 and taken into the ejection apparatus 3a.

A tank 30 is connected to the ink-jet head 22 through a pipe 32 for conveying the material to be ejected. The tank 30 contains a material to be ejected 34, which is ejected from the nozzles on the nozzle formation surface 26, or the composition of the present invention.

The pipe 32 includes a joint 32a and a valve 32b for ejecting bubbles from the ink-jet head 22. The joint 32a grounds the flow path of the material to be ejected 34 in order to prevent the inside of the flow path of the pipe 32 from being charged. The valve 32b is used in the case where the material to be ejected is sucked from inside of the ink-jet head 22 using a suction cap 40 as described below. That is, when the material to be ejected within the ink-jet head 22 is sucked by the suction cap 40, the valve 32b is closed, and thus, the material to be ejected is prevented from flowing out of the tank 30. Thus, when the material to be ejected is sucked by the suction cap 40, the flow rate of the material to be ejected is increased and bubbles within the ink-jet head 22 are quickly ejected.

The ejection apparatus 3a includes a sensor 36 for controlling the amount of the material to be ejected which is contained within the tank 30, or the level of the liquid surface 34a of the composition of the present invention. The sensor 36 controls the level so that the difference h (hereinafter referred to as water head value) between the end portion 27 of the nozzle formation surface 26 of the ink-jet head 22 and the liquid surface 34a of the material to be ejected 34 within the tank 30 is kept within a predetermined range. By controlling the level of the liquid surface 34a, the material to be ejected 34 within the tank 30 is fed to the ink-jet head 22 under a pressure within a predetermined range. As a result, the material to be ejected 34 can be stably ejected from the ink-jet head 22.

In addition, a suction cap 40 for sucking the material to be ejected within the nozzles of the ink-jet head 22 is placed so as to face the nozzle formation surface 26 of the ink-jet head 22 at a certain distance. This suction cap 40 is formed in such a manner as to be movable in the direction along the Z axis, illustrated by the arrow in FIG. 2, and make contact with the nozzle formation surface 26 so that the number of nozzles on the nozzle formation surface 26 are surrounded, and form a closed space with the nozzle formation surface 26. Thus, the nozzles can be blocked from the open air.

The material to be ejected within the nozzles of the ink-jet head 22 is sucked by the suction cap 40 in a state where the ink-jet head 22 is not ejecting the material to be ejected 34, for example when the ink-jet head 22 is retracted to a retracted position and the table 28 is retracted to the position illustrated by the broken line.

In addition, a flow path is provided beneath the suction cap 40. A suction valve 42, a suction pressure detecting sensor 44 for detecting abnormal suction, and a suction pump 46 such as a tube pump are placed in this flow path. The material to be ejected 34 is sucked by the suction pump 46, and thereby conveyed within the flow path so as to be contained in a waste liquid tank 48.

In the following embodiment, liquid ejection apparatuses 3b and 3c illustrated in FIG. 1 have the same configuration as the ejection apparatus 3a, except that the material to be ejected is different.

Next, the present invention is described in detail with reference to a method for manufacturing a liquid crystal display illustrated in FIG. 3. FIG. 3 is a schematic cross sectional view illustrating a liquid crystal display manufactured in accordance with one embodiment of the present invention.

The liquid crystal display illustrated in FIG. 3 is a passive matrix type semi-transmission reflective color liquid crystal display. Although the liquid crystal display is a passive matrix type in this embodiment, it should be understand that an active matrix type may be used alternatively. A liquid crystal display 50 includes a lower substrate 52a in the form of a rectangular plate made of glass, plastic or the like, an upper substrate 52b which is placed so as to face the lower substrate 52a via a sealing material and spacers (not shown), and a liquid crystal layer 56 which is placed between the lower substrate 52a and the upper substrate 52b.

A plurality of segment electrodes 58 and a liquid crystal orientation film 60 are placed between the lower substrate 52a and the liquid crystal layer 56 in this order, starting from the lower substrate 52a. The segment electrodes 58 are formed in stripes, as illustrated in FIG. 3, and are formed of a transparent conductive film of, for example, an indium tin oxide (hereinafter referred to as “ITO”). The liquid crystal orientation film 60 is formed of a material for forming a liquid crystal orientation film.

A color filter 62, an overcoat film 66, a common electrodes 68 and a liquid crystal orientation film 70 are placed between the upper substrate 52b and the liquid crystal layer 56 in this order, starting from the upper surface 52b. The color filter 62 has pigment layers 62r, 62g and 62b for each color: red (R), green (G) and blue (B) and a black matrices 64 are placed among the respective pigment layers 62r, 62g and 62b, or on the borders. The black matrices 64 are formed of resin black or a metal such as chromium (Cr) having low light reflectance. The respective pigment layers 62r, 62g and 62b of the color filter 62 are placed so as to face the segment electrodes 58 on top of the lower substrate 52a.

The overcoat film 66 eliminates difference in level of the pigment layers 62r, 62g and 62b and protects the surface of the respective pigment layers. The film 66 is formed of an acryl resin, a polyimide resin or an inorganic film such as a silicon oxide film.

The common electrodes 68 are formed of a transparent conductive film of ITO or the like. The electrodes 68 are formed in stripes in locations perpendicular to the segment electrodes 58 on the lower substrate 52a. The liquid crystal orientation film 70 may be formed of a polyimide resin.

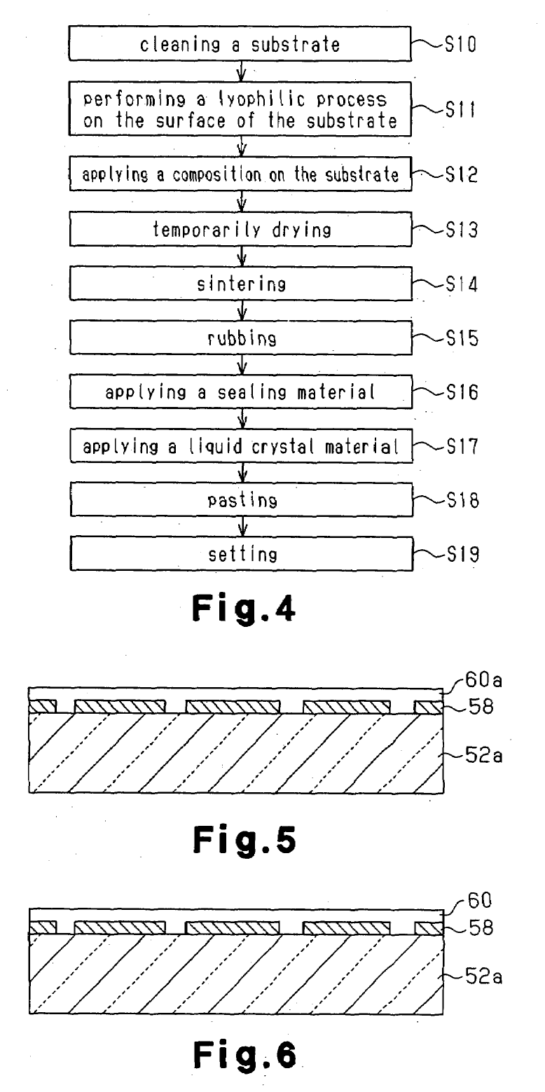

The liquid crystal display illustrated in FIG. 3 can be manufactured through steps S10 to S19, as illustrated in FIG. 4. In the following, the respective steps are described in sequence.

First, a substrate on which a liquid crystal orientation film is formed is prepared.

The substrate may be a transparent substrate made of glass such as float glass or soda glass and plastic such as polyethylene terephthalate, polybutylene terephthalate, polyether sulfone or polycarbonate. The transparent conductive film provided on one surface of the substrate may be a NESA film (registered trademark, PPG corporation, United States) made of tin oxide (SnO₂) and an ITO film made of indium oxide-tin oxide (In₂O₃—SnO₂). For the patterning of the transparent conductive film, a photo etching method or a method using a mask in advance can be used. In the present embodiment, a lower substrate 52a having segment electrodes 58 thereon is used.

Next, in the step 10, the surface of the substrate having on which an orientation film is to be formed is cleaned. In particular, the lower substrate 52a having segment electrodes 58 thereon is conveyed on the belt conveyor A to the cleaning apparatus 1 so as to be taken into the cleaning apparatus 1. The lower substrate 52a is cleaned with an alkaline based detergent, pure water or the like. Then a drying process is carried out at a predetermined temperature for a predetermined period of time, for example at a temperature from 80° C. to 95° C. for 5 to 10 minutes. The lower substrate 52a which was cleaned and dried is conveyed to the lyophilic processing apparatus 2 on the belt conveyor A.

Next, in the step S11, a lyophilic process is carried out on the surface of the substrate. In particular, the lower substrate 52a that is conveyed to the lyophilic processing apparatus 2 on the belt conveyor A is taken into the lyophilic processing apparatus 2, and a lyophilic process is carried out on the surface thereof through radiation with ultraviolet rays or a plasma process. By carrying out the lyophilic process on the substrate, the wettability of the composition of the present invention which is to be applied is increased, and thus, a more uniform and flat liquid crystal orientation film having high adhesiveness can be formed on the substrate.

Next, in the step S12, the composition of the present invention is applied on the substrate that underwent the lyophilic process in the step S11. In particular, the lower substrate 52a is conveyed to the liquid ejection apparatus 3a on the belt conveyor A, mounted on the table 28 and then taken into the liquid ejection apparatus 3a. Within the liquid ejection apparatus 3a, the composition of the present invention contained within the tank 30 is ejected via the nozzles on the nozzle formation surface 26 and applied onto the lower substrate 52a.

Next, in the step S13, a process for temporarily drying the composition is carried out. In particular, the lower substrate 52a is conveyed to the drying apparatus 4 on the belt conveyor A, taken into the drying apparatus 4 and temporarily dried at, for example, a temperature from 60° C. to 200° C. After the temporary drying, the lower substrate 52 is moved to the belt conveyor A and conveyed to the sintering apparatus 5 on the belt conveyor A.

Next, in the step S14, a process for sintering the composition is carried out. In particular, the lower substrate 52a that is conveyed to the sintering apparatus 5 on the belt conveyor A is taken into the sintering apparatus 5, and a sintering process at a temperature, for example, from 180° C. to 250° C. is carried out.

When a composition containing a polyamic acid is used, dehydration and cyclization progress during this sintering process and the applied film may be further imidized. The film thickness of the resultant applied film is usually 0.001 μm to 1 μm, preferably 0.005 μm to 0.5 μm.

As described above, a lower substrate 52a having a applied film 60a of the inventive composition formed thereon is obtained as illustrated in FIG. 5. The lower substrate 52a is moved to the belt conveyor A and conveyed to the rubbing apparatus 6 on the belt conveyor A.

Next, in the step S15, a rubbing process is carried out on the applied film 60a formed on the substrate. In particular, the lower substrate 52a that is conveyed to the rubbing apparatus 6 on the belt conveyor A is taken into the rubbing apparatus 6 and rubbed with a roll around which a cloth made of fibers in one direction. The fibers may be formed of nylon, rayon or cotton. As a result, orientation of liquid crystal molecules is provided in the applied film 60a, as illustrated in FIG. 6, and thus, a liquid crystal orientation film 60 is formed.

In order to improve the properties of the liquid crystal display elements in terms of visibility, a further process may be optionally conducted to the film formed of the inventive composition as disclosed in Japanese Laid-Open Patent Publications 6-222366, 6-281937 and 5-107544. Japanese Laid-Open Patent Publications 6-222366 and 6-281937 discloses a process for changing the pre-tilt angle by partially irradiating the liquid crystal orientation film with ultraviolet rays. Japanese Laid-Open Patent Publication 5-107544 discloses a process for changing the orientation of the liquid crystal in the liquid crystal orientation film by partially forming a resist film on the surface of the liquid crystal orientation film on which a first rubbing process was carried out and removing the resist film after a second rubbing process is carried out in a direction different from the direction of the rubbing in the first rubbing process.

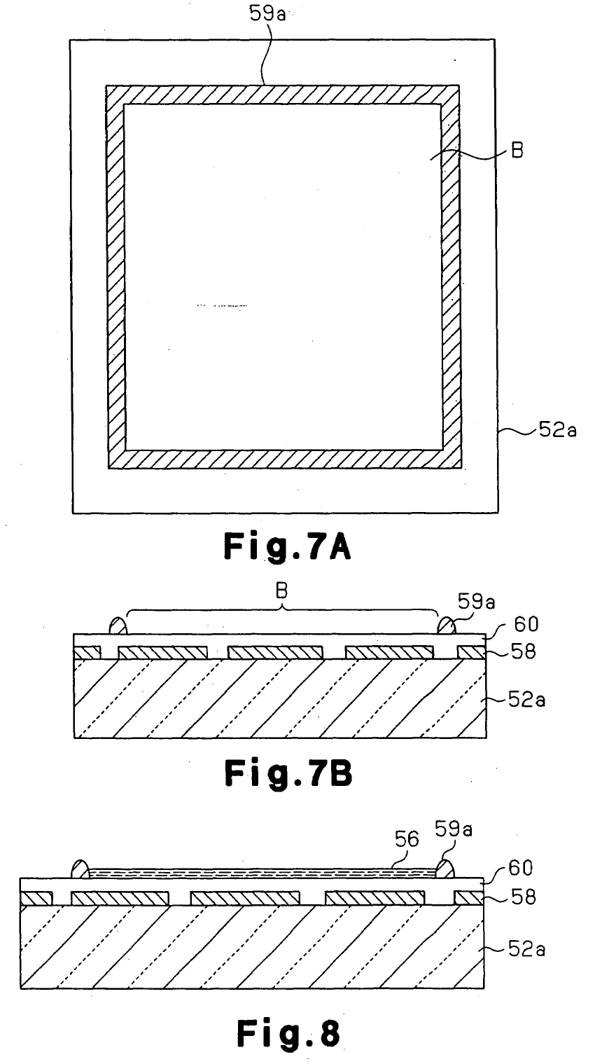

Next, in the step S16, the lower substrate 52a having the film 60 thereon is moved to the belt conveyor A and conveyed to the liquid ejection apparatus 3b on the belt conveyor A so as to be taken into the liquid ejection apparatus 3b. In the liquid ejection apparatus 3b, as illustrated in FIGS. 7A and 7B, a solution of the material for forming a sealing layer is applied so as to surround a liquid crystal displaying region B on top of the film 60. In FIGS. 7A and 7B, a numeric 59a is the applied film of the solution of the sealing material.

The solution of the sealing material may be any known adhesives which join the lower substrate and the upper substrate. The solution may include, for example, droplets or compositions containing an ionized radiation setting resin and droplets or compositions containing a thermosetting resin. An ionized radiation setting resin composition is preferred because of the ease of its handling. The thermosetting resin compositions and the ionized radiation setting resin compositions are not particularly limited, and any those known in the art can be used.

Next, in the step 17, the substrate having a solution of the sealing material applied thereon is moved to the belt conveyor A, conveyed to the liquid ejection apparatus 3c, and taken into the liquid ejection apparatus 3c. In the liquid ejection apparatus 3c, as illustrated in FIG. 8, a liquid crystal layer 56 is applied in a liquid crystal layer formation region B surrounded by the applied film 59a of the solution of the sealing material.

The liquid crystal material forming the liquid crystal 56 is not particularly limited and any materials known in the art can be used. The liquid crystal mode includes, but are not limited to, a TN (twisted nematic) type, an STN (super twisted nematic) type, an HAN (hybrid alignment nematic) type, a VA (vertical alignment) type, an MVA (multiple vertical alignment) type, an IPS (in plane switching) type and an OCB (optical compensated bend) type.

In addition, the liquid crystal layer 56 may contain spacers. Spacers are elements for keeping the thickness of the liquid crystal layer, or the cell gap, constant. The material for the spacers is not particularly limited, and any materials known in the art can be used. In addition, separately from the liquid crystal material, a functional liquid containing spacers may be applied before or after the liquid crystal material is applied.

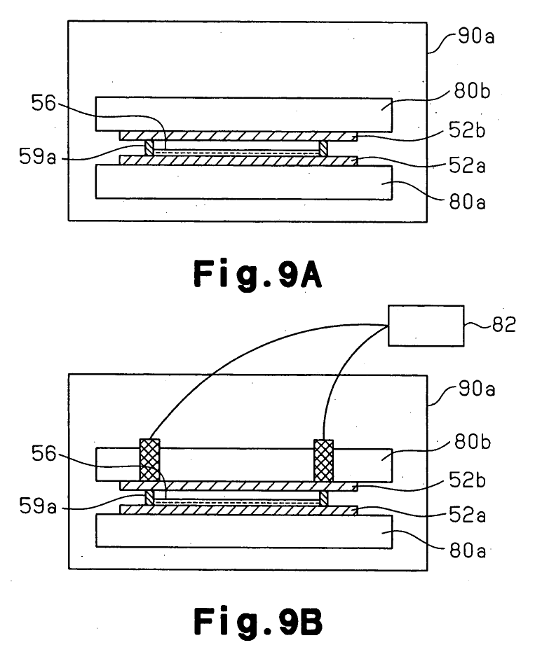

Next, in the step S18, the lower substrate 52a having a liquid crystal material 56 applied thereto is conveyed into a vacuum chamber 90a of the pasting apparatus 7, as illustrated in FIG. 9A. The lower substrate 52a is sucked and secured on top of a lower table 80a after the inside of the chamber 9a is converted to a vacuum. Meanwhile, the upper substrate 52b on which a color filter 62, a black matrices 64, an overcoat film 66, a common electrode 68 and a liquid crystal orientation film 70 (all not shown) are formed is sucked and secured onto an upper table 80b, and then, the lower and the upper substrate 52a, 52b are pasted together.

Specifically, in pasting, the lower substrate 52a and the upper substrate 52b can be aligned using a camera which recognizes alignment marks that are provided in the lower substrate 52a and the upper substrate 52b in advance. At the time of alignment, it is preferable for the gap between the lower substrate 52a and the upper substrate 52b to be set to approximately 0.2 mm to 0.5 mm, in order to increase the precision of positioning.

Next, in the step S19, a setting process is carried out on the laminated layers having the lower substrate 52a and the upper substrate 52b pasted together. The setting process is carried out using a setting apparatus. The setting apparatus may include an apparatus which radiates ionized radiation and a heating apparatus. In this embodiment, an ultraviolet ray radiating apparatus 82 is used. As illustrated in FIG. 9B, ultraviolet rays is radiated from the ultraviolet ray radiating apparatus 82 to set the sealing layer 59a through irradiation.

Next, the reduced pressure within the chamber 9a is released so that the pressure becomes the same as the atmospheric pressure, and thus, the lower substrate 52a and the upper substrate 52b that were in a sucked state are released from each other.

Subsequently, polarizing plates are pasted on the outer surface of the liquid crystal cell, or the surface on the side opposite to the side on which a liquid crystal cell is placed on each substrate, so that the direction of polarization of the polarizing plates coincides with or becomes perpendicular to the direction of rubbing of the liquid crystal orientation film formed on the substrate. The polarizing plates may be polarizing plates formed of polarizing films referred to as H films where iodine has been absorbed in polyvinyl alcohol while being expanded and oriented, and polarizing plates where an H film is sandwiched by cellulose acetate protective films.

The liquid crystal display illustrated in FIG. 3 can be manufactured as described above. Since the resultant liquid crystal display includes liquid crystal orientation films formed of the composition of the present invention using the liquid ejection apparatus 3a, such display is high quality and low cost.

Although, in the present embodiment, a liquid crystal orientation film is formed using a rubbing process in the step S15, orientation can be provided in the liquid crystal by radiating polarized radiation, as disclosed in, for example, Japanese Laid-Open Patent Publication 2004-163646.

In addition, although, in the present embodiment, a liquid crystal layer is formed by applying a liquid crystal material using a liquid ejection apparatus 3c in the step S17, two substrates on which a liquid crystal orientation film is formed may be fabricated. The two substrates are arranged so as to face each other over a gap, or a cell gap, so that the rubbing direction in the respective liquid crystal orientation films becomes perpendicular or antiparallel in relation to each other. The peripheral portions of the two substrates are pasted together with a sealing agent. Liquid crystal is injected into and fills the cell gap that is defined by the surface of the substrates and the sealing agent. The holes for injection are then sealed and the liquid crystal layer is formed.

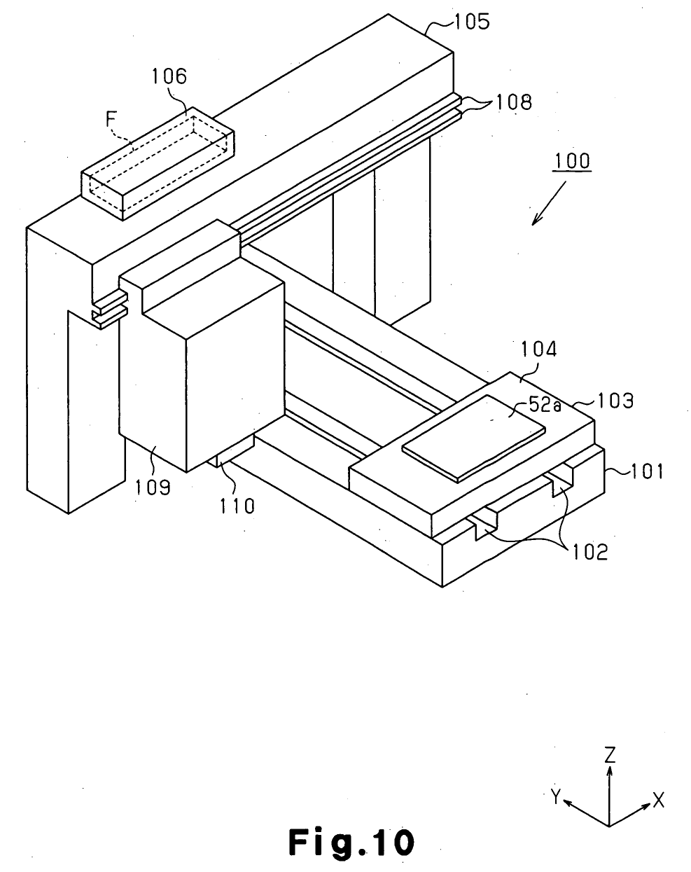

Referring to FIGS. 10-12, an apparatus for forming a liquid crystal orientation film, or a liquid ejection apparatus 100, that forms the liquid crystal orientation film 60 on the lower substrate 52a of the liquid crystal display 50 will be explained.

FIG. 10 is a perspective view of the entire liquid ejection apparatus 100. The apparatus 100 is an apparatus for forming a liquid crystal orientation film and includes a base 101 in a parallel-piped shape. A pair of guide grooves 102, which extend in the longitudinal direction, or Y direction, of the base 101, are formed on the base 101. A stage 103, which moves along the grooves 102 in main scanning direction, or Y direction, is provided on the grooves 102. A mounting surface 104 is defined on the upper surface of the stage 103. A lower substrate 52a having the segment electrodes 58 on its upper side may be mounted on the mounting surface 104 so that the lower substrate 52a in a mounted state is fixedly positioned with respect to the stage 103. Although the lower substrate 52a is mounted on the mounting surface 104 in this embodiment, a upper substrate 52a having the common electrodes 68 on its upper side may be mounted alternatively.

A guide member 105 extends over the base 101 in sub scanning direction, or X direction that is perpendicular to the main scanning direction. The guide member 105 is shaped like a gate. A reservoir tank 106 is provided on the guide member 105. The tank 106 retains a composition F for forming a liquid crystal orientation film.

A feeding tube T (in FIG. 12) is connected to the tank 106 and the composition F contained in the tank 106 is supplied the liquid ejection head 110 via the tube T at a predetermined pressure. The composition F that is supplied to the ejection head 110 is ejected from the ejection head 110 as droplets Fb toward the lower substrate 52a mounted on the mounting surface 104.

A pair of guide rails 108 are formed below the guide member 105, extending along the entire width of the guide member 105 in X direction. A carriage 109 is attached to the guide rails 108. The carriage 109 moves in X direction guided by the guide rails 108. The ejection head 110 is mounted in the carriage 109. The ejection head 110 serves as a liquid ejection device.

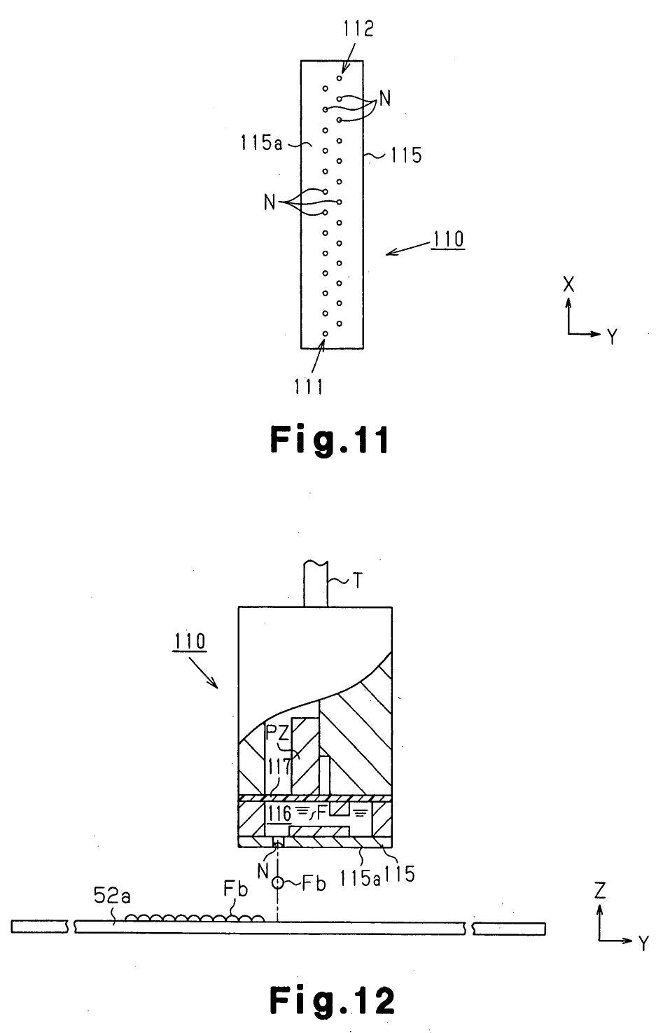

FIG. 11 is a bottom view illustrating the ejection head 110 viewed from the stage 103. A nozzle plate 115 of the ejection head 110 includes a first line 111 and a second line 112 of the nozzles. Each of the lines 111 and 112 include a plurality of nozzles N. The nozzles N of the first line 111 and the nozzles N of the second line 112 are alternately arranged in X direction. That is, the ejection head 110 include 180*2=360 nozzles N per inch in X direction (i.e. maximum resolution is 360 dpi).

FIG. 12 is an enlarged cross sectional view illustrating a part of the liquid ejection head. The feeding tube T is connected to the upper surface of the ejection head 110. The composition F for forming a liquid crystal orientation film contained in the tank 106 is supplied to the ejection head 110, as previously described. A cavity 116 is defined above each of the nozzles N and communicate with the tube T. Each of the cavities 116 supplies the composition F from the tube T to the corresponding one of the nozzles N. An oscillation plate 117 is bonded with the upper surfaces of the walls defining each of the cavities 116. Each of the oscillation plates 117 oscillates in an upward-downward direction and increases or reduces the volume of the corresponding one of the cavities 116. Piezoelectric elements PZ are arranged on the oscillation plates 117 in correspondence with the nozzles N. Each of the piezoelectric elements PZ expands or contracts to cause oscillation of the corresponding one of the oscillation plates 117 in the upward-downward direction. The oscillation of the each of the oscillation plates 117 in the upward-downward direction causes the composition F ejected from the corresponding one of the nozzles N as a liquid droplet Fb having a predetermined size. The droplet Fb that is ejected falls in −Z direction and reaches the lower substrate 52a that moves under the nozzle N.

Referring to FIG. 14, electrical configuration of the liquid ejection apparatus 100 will be explained.

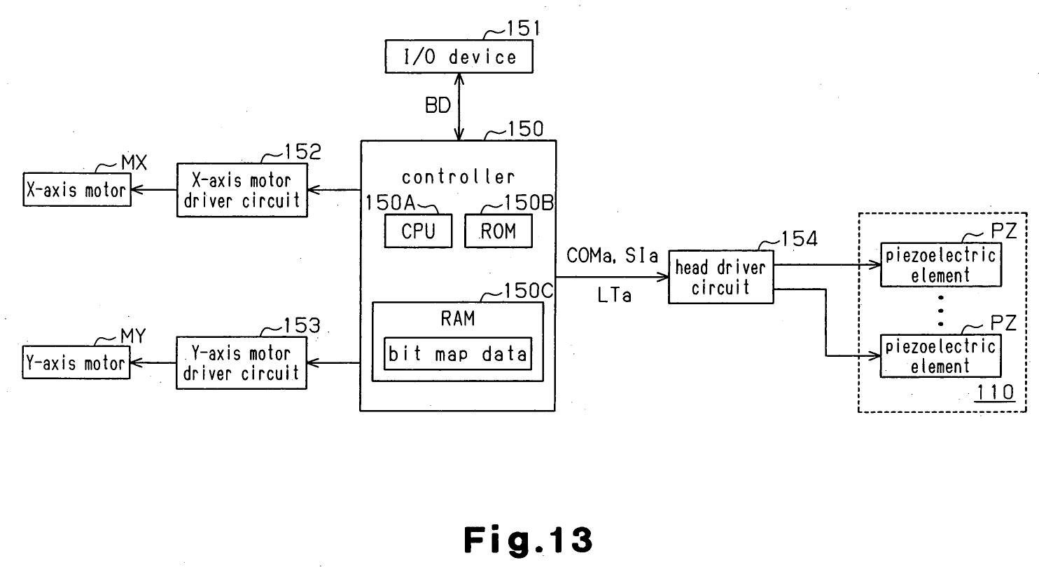

In FIG. 13, a controller 150 includes a CPU 150A, a ROM 150B, and a ROM 150C. The controller 150 stores various data and various control programs and transports the stage 103, transport the carriage 109, and operates the ejection head 110 in correspondence with such data and control programs.

An input and output (I/O) device 151 including various manipulation switches and a display is connected to the controller 150. The processing condition of various processing treatments that the liquid ejection apparatus 100 performs is displayed on the I/O device 151. The I/O device 151 generates bit map data BD on the lower substrate 52a with the droplets Fb for forming a pattern of the liquid crystal orientation film 60 and transmit the bit map data BD to the controller 150.

The bit map data BD are data that indicate whether to excite the piezoelectric elements PZ in correspondence with the corresponding bit values (0 or 1). The bit map data BD indicate whether to eject the droplets Fb onto the lower substrate 52a that the ejection head 110 or the respective nozzles A of which encounter. That is, the bit map data BD are data to eject the droplet Fb at their ejection target positions for forming a predetermined pattern of the film 60 on the lower substrate 52a. In this embodiment, a pattern of the film 60 is determined in an experiment or a test in advance and the bit map data BD are generated based on the determined pattern.

The controller 150 is connected to an X-axis motor driver circuit 152 and outputs a corresponding control signal to the X-axis motor driver circuit 152. In correspondence with the control signal of the controller 150, the X-axis motor driver circuit 152 operates to rotate the X-axis motor MX in a forward direction or a reverse direction to move the carriage 109. The controller 150 is connected to a Y-axis motor driver circuit 153 and outputs a corresponding control signal to the Y-axis motor driver circuit 153. In correspondence with the control signal of the controller 150, the Y-axis motor driver circuit 153 operates to rotate the Y-axis motor MY in a forward direction or a reverse direction.

The controller 150 is connected to a head driver circuit 154 and outputs a corresponding ejection timing signal LTa to the head driver circuit 154. The timing signal LTa is synchronized with a prescribed ejection frequency. The controller 150 synchronizes the piezoelectric element drive voltage COMa with the prescribed ejection frequency and supplies the drive voltage COMa to the ejection head driver circuit 154.

The controller 41 generates ejection control signals SIa for forming a pattern synchronized with a prescribed frequency based on the bit map data BD and serially transfers the ejection control signals SIa to the ejection head driver circuit 154. The ejection head driver circuit 154 converts the serial ejection control signals SIa from the controller 150 to the parallel signals corresponding to the piezoelectric elements PZ. Every time receiving the ejection timing signal LTa from the controller 150, the ejection head driver circuit 154 latches the converted control signals SIa and supplies the piezoelectric element drive voltage COMa to the piezoelectric elements PZ that are selected based on the ejection control signals SI.

A method for forming a liquid crystal orientation film 60 on the lower substrate 52 using a liquid ejection apparatus 100 will be explained below.

As illustrated in FIG. 10, the ejection head 110 wait in a standby position which is spaced away from the stage 103 in a −X direction. The bit map data BD for forming a pattern of the film 60 on the lower substrate 52a is transmit from the I/O device 151 to the controller 150. Thus, the controller 150 stores the bit map data BD from the I/O device 151.

The lower substrate 52 is then mounted on the stage 103. The lower substrate 52 is placed on the stage at a location which is in −Y direction and command signals to start operation are output from the I/O 151 and transmitted to the controller 150.

The controller 150 drives the X-axis motor MX to move the ejection head 110 in the standby position in +X direction. Then, when the ejection head 110 is moved to the position under which the lower substrate 52a is to move in +Y direction, the controller 150 deactivates the X-axis motor MX and activates the Y-axis motor MY to move the lower substrate 52a in +Y direction.

After moving the substrate 52a in +Y direction, the controller 150 generates control signals SIa for patterning based on the bit map data BD and output the control signals SIa and the drive voltage COMa to the head driver circuit 154. That is, the controller 150 controls the respective piezoelectric elements PZ via the head driver circuit 154 thereby cause the droplets Fb to be ejected from the nozzles N that are selected for forming the film 60 on the substrate 52a when the substrate 52a passes under the ejection head 110.

When the supply of the droplets Fb to the substrate 52a in Y direction is over, the controller 150 deactivates the Y-axis motor MY and activates the X-axis motor MX to move the ejection head 110 to a position under which the lower substrate 52a is to move in −Y direction and the next region on the substrate 52a that is in a −X direction of the previous region is to be applied the droplets Fb.

When the ejection head 110 is fed, the controller 150 drives the Y-axis motor MY to move or scan the stage 103 in −Y direction. After the stage 103 starts moving, the controller 150 generates control signals SIa for patterning based on the bit map data BD and output the control signals SIa and the drive voltage COMa to the head driver circuit 154. That is, the controller 150 controls the respective piezoelectric elements PZ via the head driver circuit 154 thereby cause the droplets Fb to be ejected from the nozzles N that are selected for forming the film 60 on the substrate 52a when the substrate 52a passes under the ejection head 110.

A similar operation is repeated to place the droplets Fb of the composition C to finish feeding the composition C to the substrate 52a. Thus, the composition F is uniformly spread over the entire surface of the substrate 52a. The substrate 52a is dried to form the liquid crystal orientation film 60.

### EXAMPLES

The present invention is described in further detail in the following examples. It is to be understood that the present invention is by no means limited by the following examples.

γ-butylolactone, butyl cellosolve and N-methyl-2-pyrrolidone were mixed with the ratio illustrated in the following first table to obtain mixed solvents. Polyimide was dissolved in each of the mixed solvents, and thus, compositions for forming a liquid crystal orientation film for Examples 1 to 3 and Comparative Examples 1 and 2 were respectively prepared (solid concentration: 8 weight %).

The resultant compositions were applied on ITO substrates using a liquid ejection apparatus so that the thickness of the dried film became 60 nm, and thus, liquid crystal orientation films were formed. Whether or not streaks caused by the unevenness of the liquid crystal orientation films occurred was visually observed, and the evaluation was conducted. x is the case where streaks were generated due to unevenness and o is the case where no streaks were generated. The results are collectively shown in the Table 1.

TABLE 1

| | | | | | Com- | Com- |
|---|---|---|---|---|---|---|
| | | | | | par- | par- |
| | | | | | ative | ative |
| | | Exam- | Exam- | Exam- | Exam- | Exam- |
| | | ple 1 | ple 2 | ple 3 | ple 1 | ple 2 |
| γ-butylolactone | weight | 95 | 93 | 93 | 95 | 97 |
| N-methyl-2- | % | 5 | 5 | 8 | 3 | 0 |
| pyrrolidone | | | | | | |
| butyl cellosolve | | 0 | 2 | 2 | 2 | 3 |
| streaks | | ◯ | ◯ | ◯ | X | X |

As shown in Table 1, no streaks were generate in the liquid crystal orientation films formed using the compositions including no less than 5 weight % and less than 10 weight % of N-methyl-2-pyrrolidone relative to the total solvent (Examples 1 to 3). Meanwhile, streaks were generated in the liquid crystal orientation film formed using the composition including less than 5 weight % of N-methyl-2-pyrrolidone relative to the total solvent (Comparative Example 1) and the composition including no N-methyl-2-pyrrolidone (Comparative Example 2).

The present examples and embodiments are to be considered as illustrative and not restrictive and the invention is not to be limited to the details given herein, but may be modified within the scope and equivalence of the appended claims.

What is claimed is:

1. A composition for forming a liquid crystal orientation film using a liquid ejection apparatus comprising:
(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and
(b) a material for forming a liquid crystal orientation film.

2. The composition according to claim 1, wherein the aprotic polar solvents other than γ-butylolactone include amide based solvents, sulfoxide based solvents, ether based solvents and nitride based solvents.

3. The composition according to claim 2, wherein the aprotic polar solvents other than γ-butylolactone include amide based solvents.

4. The composition according to claim 3, wherein the at least one type of solvent is N-methyl-2-pyrrolidone.

5. The composition according to claim 1, wherein the composition is a solution having a surface tension of 30 mN/m to 45 mN/m.

6. The composition according to claim 1, wherein the composition is a solution having a viscosity of 3 mPa·s to 20 mPa·s.

7. The composition according to claim 1 wherein the material for forming a liquid crystal orientation film is a polymer having at least one type selected from a repeating unit represented by formula (I) and a repeating unit represented by formula (II): 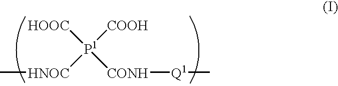
(wherein P¹ is a tetravalent organic group and Q¹ is a divalent organic group.) 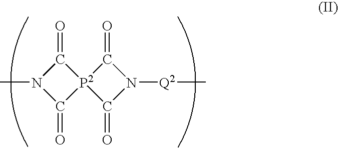
(wherein P² is a tetravalent organic group and Q² is a divalent organic group.)

8. The composition according to claim 1 further comprising a poor solvent, wherein the at least one type of solvent is between no less than 5 weight % and less than 30 weight % of the entire solvent.

9. An apparatus for forming a crystal liquid orientation film on substrate comprising:
an ejection head having a plurality of nozzles; and
a composition for forming a crystal liquid orientation film that is ejected from the plurality of nozzles to the substrate as a droplet, wherein the composition includes:
(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and
(b) a material for forming a liquid crystal orientation film.

10. A liquid crystal display comprising:
a substrate; and
a liquid crystal orientation film placed on the substrate, wherein the film is formed of a composition including:
(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and
(b) a material for forming a liquid crystal orientation film.

11. A liquid crystal display comprising:
an upper substrate having a liquid crystal orientation film placed thereon;
a lower substrate having a liquid crystal orientation film placed thereon;
a sealing material for sealing the upper and lower substrates; and
liquid crystal placed in a portion surrounded by the sealing material;
wherein the liquid crystal orientation film placed at least one of the upper substrate and the lower substrate is formed of a composition including:
(a) a mixed solvent including γ-butylolactone and at least one type of solvent selected from aprotic polar solvents other than γ-butylolactone and phenol based solvents, where the at least one type of solvent is no less than 5 weight % relative to the mixed solvent; and
(b) a material for forming a liquid crystal orientation film.
